(19) United States
(12) Patent Application Publication
(10) Pub. No.: US 2013/0059196 A1
(43) Pub. Date: Mar. 7, 2013

(54) GALVANIC CELL

(71) Applicants: Siegfried Bauer, Linz (AT); Reinhard Schwoediauer, Linz (AT); Christian Siket, St. Marien (AT); Martin Kaltenbrunner, Linz (AT); Gerald Kettlgruber, Linz (AT)

(72) Inventors: Siegfried Bauer, Linz (AT); Reinhard Schwoediauer, Linz (AT); Christian Siket, St. Marien (AT); Martin Kaltenbrunner, Linz (AT); Gerald Kettlgruber, Linz (AT)

(73) Assignee: UNIVERSITAET LINZ, Linz (AT)

(21) Appl. No.: 13/635,729

(22) PCT Filed: Jan. 28, 2011
(86) PCT No.: PCT/AT11/00046

§ 371 Date: Oct. 10, 2012

(30) Foreign Application Priority Data
Feb. 3, 2010 (AT) A 139/2010

(51) Int. Cl. H01M 2/02

(52) U.S. Cl. 429/163

(57) ABSTRACT

A galvanic cell is described, comprising an anode layer (1), a cathode layer (2) and an electrolyte layer (4) connecting the anode layer and the cathode layer (1, 2). In order to achieve high extensibility of the cell without impairing its function it is proposed that the paste- or gel-like layers (1, 2) for the anode and cathode, which are arranged next to one another at a distance and are separated from each other by an electrically non-conducting elastomer (3), are covered by the paste- or gel-like electrolyte layer (4) bridging the non-conducting elastomer (3) and are embedded together with the electrolyte layer (4) in an elastomeric jacket (7).

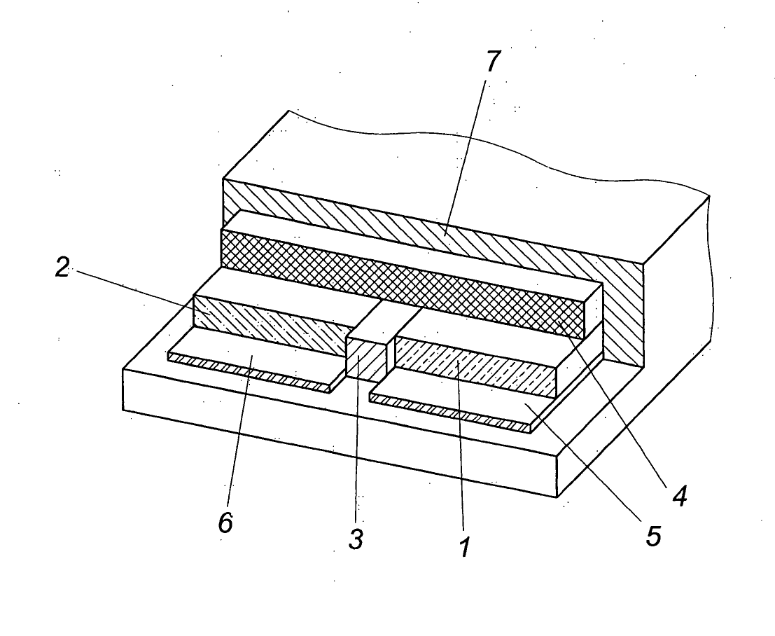

### FIELD OF THE INVENTION

The invention relates to a galvanic cell, comprising an anode layer, a cathode layer and an electrolyte layer connecting the anode layer and the cathode layer.

### DESCRIPTION OF THE PRIOR ART

In order to provide flexible batteries, it is known (EP 1 033 766 B1) to provide a plurality of layers arranged in a laminate-like way which form anodes and cathodes in an alternating manner which are separated from one another by a polymer electrolyte layer. Although the galvanic cells of said known batteries which are respectively formed by a cathode and anode with interposed elastomeric layer allow bending of the film-like, electrochemically active layers, they do not allow the extension of said cells to an extent as is required for the power supply of known extensible electronic circuits in order to enable an adjustment to potential movements of the carrier accommodating said circuits without endangering the power supply of the respective circuits.

### SUMMARY OF THE INVENTION

The invention is therefore based on the object of providing a galvanic cell of the kind mentioned above in such a way that not only bending but also the extension of the cell parallel to the electrochemically effective layers will be enabled without endangering a sufficient supply of energy.

This object is achieved by the invention in such a way that the paste- or gel-like layers for the anode and cathode, which are arranged next to one another at a distance and are separated from each other by an electrically non-conducting elastomer, are covered by the paste- or gel-like electrolyte layer bridging the non-conducting elastomer and are embedded together with the electrolyte layer in an elastomeric jacket.

As a result of the paste- or gel-like consistency of the individual, electrochemically active layers, it is ensured at first in a simple way that during an extension of the galvanic cell parallel to the individual layers said layers will follow the extension movement without imperiling their function. As a result of the arrangement of the cathode and anode layer next to one another at a distance and the additional separation of these layers for the anode and cathode by an electrically non-conducting elastomer the danger is averted that said layers, apart from the electrolyte layer, will enter into an electrochemically effective connection, which may be the case in galvanic cells with stacked cathode and anode layers when as a result of the extension the electrolyte layer between the cathode and anode layers is interrupted. The paste- or gel-like electrolyte layer bridges the non-conducting elastomeric separating layer between the two layers for the anode and cathode, so that mechanical properties are also ensured in the intermediate area between the anode and cathode which allow said insulating intermediate region to follow external extensions which are applied to the elastomeric jacket in which the electrochemically effective layers are embedded.

In order to enable taking the extension behavior of the anode and cathode of the galvanic cell in the region of the electric connecting electrodes into account in a simple way, the anode and cathode layers can each be applied to a paste- or gel-like carbon layer as connecting electrodes. The connecting electrodes have mechanical properties concerning the extension behavior which can be compared with the extension behavior of the anode and cathode.

### BRIEF DESCRIPTION OF THE DRAWING

The subject matter of the invention is shown by way of example in the drawing, which shows a galvanic cell in accordance with the invention in a partly sectional diagram.

### DESCRIPTION OF THE PREFERRED EMBODIMENT

The illustrated galvanic cell comprises a paste- or gel-like anode layer 1 and a cathode layer 2 which is arranged adjacent from said anode layer 1 at a distance therefrom and which also has a paste- or gel-like consistency. An electrically non-conducting elastomer 3 is provided between the two layers 1, 2 for the anode and cathode. The anode layer 1 and the cathode layer 2 are covered by a paste-or gel-like electrolyte layer 4 by bridging the non-conducting elastomer 3. The connecting electrodes 5 and 6 for the anode layer 1 and the cathode layer 2 are formed by paste-or gel-like carbon layers in order to ensure mechanical properties which are comparable with those of the anode and cathode layers 1, 2. The electrochemically active layers of the galvanic cell are embedded in an elastomeric jacket 7, which jacket can be subjected to the forces which occur parallel to the electrochemically active layers and is extended according to these forces. This extension of the elastomeric jacket 7 produces a respective lengthening of the electrochemically active layers as a result of their paste-or gel-like consistency, with the function of the galvanic cell not being impaired however. In particular, the cooperation of the electrolyte layer 4 with the anode and cathode layers 1, 2 is not impaired because the anode layer 1 and the cathode layer 2 remain separate from one another by the non-conducting elastomer 3 even under high extensions, e.g. the double initial length and beyond, and are only in connection by the electrolyte layer 4 which bridges the non-conducting elastomer 3.

The galvanic cell in accordance with the invention can advantageously be arranged as a manganese dioxide zinc cell. In this case, the anode layer 1 is composed of a paste containing manganese dioxide, carbon and an electrolyte (NH₄Cl, ZnCl₂) for example, whereas the cathode layer 2 comprises a gel made of zinc, carbon and xanthan. The electrolyte layer 4 can be an electrolyte gel with xanthan as a gelling agent. The connecting electrodes 5 and 6 form a paste made of carbon and silicon oil. An acryl can be used for example for the elastomeric jacket 7. In accordance with the illustrated embodiment, the anode layer 1 and the cathode layer 2 can each have a base area of 1 cm² for example at a total thickness of the cell of 2 mm.

Galvanic cells in accordance with the invention are not limited to such a composition. The relevant precondition is always that the electrochemically active components can be produced as pastes or gels. Extensible alkaline-manganese cells can be used instead of manganese dioxide zinc cells. In this case, the acidic electrolyte which is used in the manganese dioxide zinc cells must be replaced by an alkaline electrolyte (e.g. an aqueous solution of 40% by weight of KOH and 4% by weight of ZnCl₂).

Zinc-air cells are also possible, wherein the manganese-alkaline cells are extended in the simplest case in such a way that the paste of the anode layer containing the manganese dioxide is provided with an air-permeable configuration by suitable perforation of the elastomer. The perforation shall occur in such a way that the elastomer is permeable for oxygen but not the cathode gel.

It is understood that other electrolytes such as conducting polymer gels and the like are possible. The relevant aspect for each embodiment of a galvanic cell is that the anode and the cathode are arranged adjacent to one another and are separated from one another by a non-conducting elastomer, with the electrolyte covering the anode and cathode by bridging the non-conducting elastomer.

1. A galvanic cell, comprising an anode layer (1), a cathode layer (2) and an electrolyte layer (4) connecting the anode layer and the cathode layer (1, 2), wherein the paste- or gel-like layers (1, 2) for the anode and cathode, which are arranged next to one another at a distance and are separated from each other by an electrically non-conducting elastomer (3), are covered by the paste- or gel-like electrolyte layer (4) bridging the non-conducting elastomer (3) and are embedded together with the electrolyte layer (4) in an elastomeric jacket (7).

2. A galvanic cell according to claim 1, wherein the anode and cathode layers (1, 2) are applied to one paste- or gel-like carbon layer each as connecting electrodes (5, 6).
